(19) United States
(12) Patent Application Publication
(10) Pub. No.: US 2021/0294682 A1
(43) Pub. Date: Sep. 23, 2021

(54) PREDICTING COST REDUCTION OF EVENT CORRELATION IN FAULT EVENT MANAGEMENT

(71) Applicant: International Business Machines Corporation, Armonk, NY (US)

(72) Inventors: Peter Mills, London (GB); Jack Richard Buggins, London (GB); Matthew Richard James Thornhill, London (GB); Joshua Suckling, London (GB)

(21) Appl. No.: 16/823,213

(22) Filed: Mar. 18, 2020

(51) Int. Cl. G06F 11/07; G06N 5/04; G06N 20/00

(52) U.S. Cl. CPC G06F 11/079; G06F 11/0751; G06N 20/00; G06N 5/04; G06F 11/0778

(57) ABSTRACT

Aspects of the present invention disclose a method, computer program product, and system for predicting cost reduction of event correlation in fault event management. The method includes one or more processors receiving a plurality of candidate correlation groups of events in a set of fault events. The method further includes, for each candidate correlation group of events, one or more processors predicting a resource cost reduction in resolving the respective correlation group of events compared to resolving all events in the respective correlation group individually. The method further includes one or more processors analyzing the predicted resource cost reductions for the plurality of candidate correlation groups of events. The method further includes one or more processors selecting a candidate correlation group based on the analysis of predicted resource cost reductions.

### BACKGROUND OF THE INVENTION

The present invention relates generally to the field of fault event management, and more particularly to predicting cost reduction of event correlation in fault event management.

Data center, system management, and network management include fault event management and root cause analysis to resolve and manage fault events. When faults or irregular events occur in a data center, a notification is sent to an event manager, for example, in the form of an alert. At the event manager, the event may be de-duplicated, correlated, and enriched. An event may be handled based on a rules engine or may prompt the generation of a ticket for a help desk. To reduce operation cost, it is known to correlate commonly co-occurring alerts so as to allow an operator to only work on one problem.

For event correlation, events capture event information that is used for correlation. The information depends on the event domain of interest and depends on the type of analysis of the correlation. Event information may include event time, type, resources, related objects, applications effected, annotations, instructions, etc.

Events may originate from many different sources and may be compared across sources. Event correlation may include event filtering to remove events that are considered irrelevant, event aggregation to combine similar events, and event de-duplication to merge exact duplicates of the same event. A root cause analysis may then analyze dependences between events to detect whether some events can be explained by others.

In event management, it is beneficial to correlate multiple events together to reduce the amount of effort required for an operator to diagnose and resolve problems. There are existing systems that are able to automatically infer relationships between events and perform this type of correlation.

Typically, an operations teams will want to review inferences to verify accuracy before using the inferences to perform event correlation. When large quantities of inferences exist, it can take the teams a long time to review them all.

In many cases, a large quantity of inferences, while accurate, may not be of much benefit to the operations teams in reducing the amount of effort required to resolve problems. Conversely, some of the inferences can provide a substantial reduction in effort required to resolve problems. Without a mechanism to indicate the benefits of each inference, teams may waste time examining inferences that are of low value.

### SUMMARY

Aspects of the present invention disclose a method, computer program product, and system for predicting cost reduction of event correlation in fault event management. The method includes one or more processors receiving a plurality of candidate correlation groups of events in a set of fault events. The method further includes, for each candidate correlation group of events, one or more processors predicting a resource cost reduction in resolving the respective correlation group of events compared to resolving all events in the respective correlation group individually. The method further includes one or more processors analyzing the predicted resource cost reductions for the plurality of candidate correlation groups of events. The method further includes one or more processors selecting a candidate correlation group based on the analysis of predicted resource cost reductions.

Embodiments of the present invention can provide the advantage of quantifying the cost benefit of deploying correlations. The method can obtain a prediction of the cost benefit of a correlation resulting in an optimization of review of multiple correlations for fault events.

In further aspects, predicting a resource cost reduction for each candidate correlation of a group of events further includes: one or more processors predicting a first resource cost of resolving as a group the correlation group of events; one or more processors predicting a second resource cost of a sum of the costs of resolving the events in the group individually; and one or more processors calculating a difference in the first and second predicted resource costs to obtain the predicted resource cost reduction.

Analyzing the predicted resource cost reductions can further include ranking the candidate correlation groups of events by the predicted resource cost reduction, which provides advantages when candidate correlation groups are discrete groups of events.

The candidate correlation groups may be groups with overlapping events including sub-groups of events. Analyzing the predicted resource cost reduction may include calculating combined predicted cost reductions of sub-group of events and comparing the result to a predicted cost reduction of a whole group of events.

The resource costs may be measured for an event or a group of events as one or more of the group of: personnel time required to resolve; resource downtime to resolve; and loss of service cost to resolve.

In additional aspects, predicting a first resource cost may apply a first machine learning model trained to predict resource costs for resolving correlation groups of events based on input vectors defining features of the correlations, which can provide the advantage of basing the prediction on historical costs of resolving correlated events. The input vectors may define features of the correlations in the form of one or more of the group of: a severity of events in the group; a source of each event in the group; a number of events in the group; a number of resourced affected; patterns of when the group occurs; a duration of the group; a frequency of words in the group; a degree of connectivity for events that match resources of a topology in the group. Further, the method may provide feedback to the first machine learning model of resource costs of resolving a correlation group of events for continued training of the model.

In additional aspects, predicting a second resource cost may apply a second machine learning model trained to predict resource costs for resolving individual events based on input vectors defining features of the individual events. The input vectors may define features of the individual events in the form of one or more of the group of: when the event occurred; a severity of the event; a location of the event; a description of the event. Further, the method may provide feedback to the second machine learning model of resource costs of resolving individual events for continued training of the model.

The plurality of candidate correlations of groups of events in a set of fault events may be provided by a correlation system and are based on different discovered inferences between events.

Another aspect of the preset invention discloses a method, computer program product, and system for predicting cost reduction of event correlation in fault event management. The method includes providing a first machine learning model trained to predict resource costs for resolving correlation groups of events based on input vectors defining features of the correlation groups and providing a second machine learning model trained to predict resource costs for resolving individual events based on input vectors defining features of the individual events. The method further includes, for a discovered correlation of a group of events: one or more processors applying the first machine learning model to predict a resource cost for resolving the group of events as a correlation group and one or more processors applying the second machine learning model to predict a resource cost for resolving the group of events as individual events. The method further includes one or more processors predicting a resource cost reduction in resolving a correlated of a group of events compared to a total resource cost of resolving all the events in the group individually.

Providing a first machine learning model trained to predict resource costs for resolving correlation groups of events based on input vectors defining features of the correlation groups may include: training the first machine learning model based on resolved correlation group event analysis including resource cost feedback of correlation groups of events. Providing a second machine learning model trained to predict resource costs for resolving individual events based on input vectors defining features of the individual events may include: training the second machine learning model based on resolved event analysis including resource cost feedback of individual events.

A further aspect of the present invention discloses a method, computer program product, and system for predicting cost reduction of event correlation in fault event management. The method includes one or more processors, training a first machine learning model to predict resource costs for resolving correlation groups of events based on input vectors defining features of the correlation groups. The method further includes one or more processors training a second machine learning model to predict resource costs for resolving individual events based on input vectors defining features of the individual events. The method further includes one or more processors providing the first machine learning model for predicting a resource cost for resolving a group of events as an input correlation group. The method further includes one or more processors providing the second machine learning model for predicting a resource cost for resolving the group of events in the input correlation group as individual events. The method further includes one or more processors predicting a resource cost reduction in resolving the correlation group of events as a correlation group compared to a total resource cost of resolving all the events in the group individually.

Training the first machine learning model to predict resource costs for resolving correlation groups of events may be based on resolved correlation group event analysis including resource cost feedback of correlation groups of events and training the second machine learning model to predict resource costs for resolving individual events may be based on resolved event analysis including resource cost feedback of individual events.

The method may include receiving feedback to the first machine learning model of resource costs of resolving a correlation group of events for continued training of the model and receiving feedback to the second machine learning model of resource costs of resolving individual events for continued training of the model.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

FIG. 1A is a flow diagram of an example embodiment of a method in accordance with an aspect of the present invention, in accordance with an embodiment of the present invention.

FIG. 1B is a flow diagram of a more detailed example of the method of FIG. 1A, in accordance with an embodiment of the present invention.

FIG. 2 is a flow diagram of another example embodiment of a method, in accordance with an embodiment of the present invention.

FIG. 3A is a flow diagram of an example embodiment of a method, in accordance with an embodiment of the present invention.

FIG. 3B is a flow diagram of an example embodiment of a method, in accordance with an embodiment of the present invention.

FIG. 4 is block diagram of an example embodiment of a system, in accordance with an embodiment of the present invention.

FIG. 5 is a block diagram of an embodiment of a computer system or cloud server in which the present invention may be implemented, in accordance with an embodiment of the present invention.

FIG. 6 is a schematic diagram of a cloud computing environment in which the present invention may be implemented, in accordance with an embodiment of the present invention.

FIG. 7 is a diagram of abstraction model layers of a cloud computing environment in which the present invention may be implemented, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

A method and system are provided that predict the relative benefit of deploying suggested correlation groups in fault event management based on historical cost analysis of previous events and incidents. Embodiments of the present invention recognize the value to operations teams to be able to accurately quantify the benefits of each inference when selecting correlation groups for handling fault event resolution.

Various embodiments of described method and system provide a prediction of a resource cost reduction in resolving a correlation group of events compared to resolving all the events in the group individually or in a different selection of one or more sub-groups of events within the correlation group. The prediction is based on a supervised learning of resource costs for correlation groups of events and for individual events. The supervised learning may provide a model trained to create a mapping between events and cost based on feedback from root cause analysis of resolved events including the time and cost taken to resolve correlation groups of events and the individual events.

Proposed inferences for correlations of groups of events may be passed through the model to give a predicted cost of resolving groups of events of different correlations. Uncorrelated events may be passed through the model to give predicted costs of resolving each event individually. Comparison between the costs of resolving a correlation group of events and the combined cost of resolving the uncorrelated events is used in order to determine a cost reduction of each correlation inference.

The cost reductions of different correlations may be analyzed to select optimal correlations of groups of events. The correlations may be ranked with higher cost difference than those with a smaller difference, allowing an operations team to prioritize the review of inferences which will result in the greatest cost reduction. The cost reductions may also be analyzed to determine optimal groupings or sub-groupings of events in correlations.

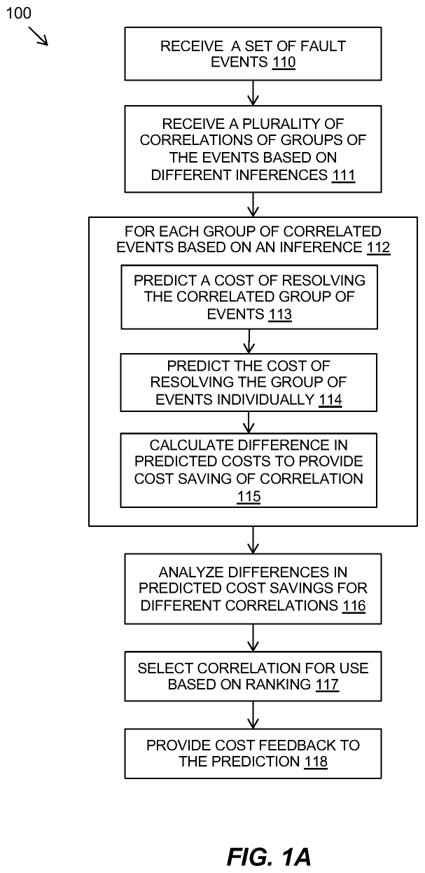

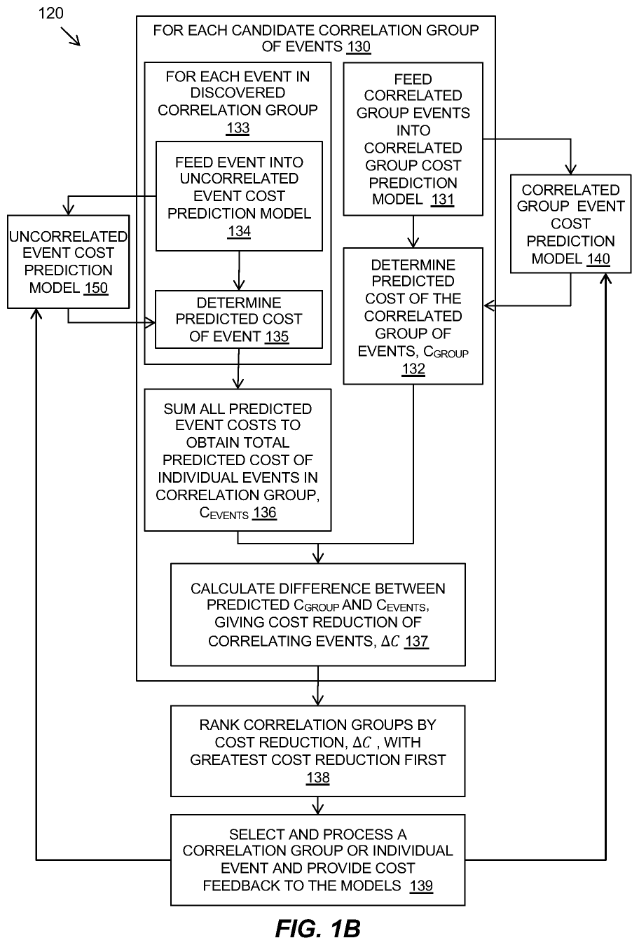

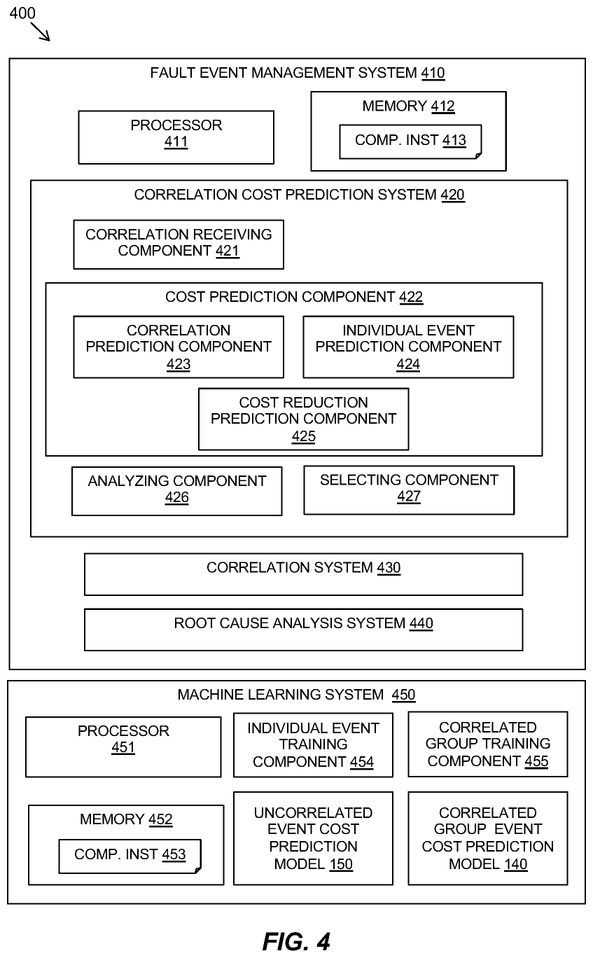

Referring to FIG. 1A, a flow diagram 100 illustrates an example embodiment of the described method carried out by a computer system for predicting cost reduction of event correlation in fault event management. In various embodiments, flow diagram 100 can be representative of processes and steps of a program and/or application that system 400 (depicted in FIG. 4) executes, in accordance with embodiments of the present invention.

In step 110 of flow diagram 100, the method incudes receiving a set of fault events. Further, in step 111 the method includes receiving a plurality of candidate correlations of groups of events applying inferences to groups of events within the set of fault events. The plurality of candidate correlations of groups of events may be provided by a correlation system and are based on different discovered inferences between events. The candidate correlations may be discovered by a correlation system that may be integrated in the same computer system or may be provided remotely (e.g., discussed in further detail with regard to FIG. 4). The plurality of candidate correlations of groups of events in the set of fault events may include candidate correlations for different groups of events within the set of fault events.

In one embodiment, the candidate correlations of groups of events may include discrete correlation groups with no common events between the correlation groups. Each correlation group is potentially valid and works independently. In another embodiment, the candidate correlations of groups may be overlapping with some or all events of one correlation group included in another correlation group. In addition, one or more correlation groups can also be sub-groups of events of another correlation group.

In further embodiments, the method of flow diagram 100 includes performing step 113, step 114, and step 115 for each candidate correlation of a group of events (i.e., as process 112). In further aspects, process 112 of flow diagram 100 includes predicting a resource cost reduction in resolving the correlation group of events compared to resolving all the events in the group individually.

Accordingly, process 112 includes predicting a resource cost reduction in resolving the correlation group of events (in step 113) and predicting the total cost of resolving the events within the group individually (step 114). Further, process 112 includes calculating the difference in the two predicted costs (step 115). In various embodiments, the predicted resource costs may relate to the system downtime, personnel time costs, and loss of service of resolving the events. In another embodiment, the resource cost reduction can be negative, showing more resource cost in resolving the correlated events compared to resolving the events individually.

As each correlation group is processed to obtain the predicted resource cost reduction (e.g., in process 112), the method of flow diagram 100 analyzes the correlation group according to the predicted resource cost reduction compared to other candidate correlation groups (step 116). Further, in step 117 method of flow diagram 100 can utilize the analysis to select a candidate correlation of a group with priority or preference going to correlations with greater cost reductions. In additional embodiments, the analysis (of step 116) may be a ranking to compare discrete correlation groups or may be an event-based analysis taking into account event overlap between the correlation groups.

Once a correlation group of events is selected and used for resolving the group of events, the method of flow diagram 100 provides cost feedback to the prediction to improve the accuracy of future predictions (step 118).

Referring to FIG. 1B, a flow diagram 120 depicts a more detailed example embodiment of the described method of FIG. 1A. In various embodiments, flow diagram 120 can be representative of processes and steps of a program and/or application that system 400 (depicted in FIG. 4) executes, in accordance with embodiments of the present invention.

For each candidate correlation of a group of events, the method of flow diagram 120 can perform process 130, which includes two branches (depicted in FIG. 1B), a first for the correlation group of events, and the second for the individual events in the correlation group.

In one branch, the method of flow diagram 120 may feed characteristics of a correlation group of events into a correlation group cost prediction model 140 (step 131) and may determine the predicted resource cost of resolving the correlation group of events as C_{group} (step 132).

The correlation group cost prediction model 140 in this embodiment is a machine learning model trained to predict resource costs for resolving correlation groups of events based on input vectors defining features of the correlations and trained resource cost outputs.

In another branch of the method, the method of flow diagram 120 may perform process 133 to feed characteristics of the individual event into an uncorrelated event cost prediction model 150 for each event in the correlation group (step 134). Then, process 133 can determine the predicted resource cost of resolving the individual event, C. (step 135). The branch of the method of flow diagram 120 corresponding to process 133 sums (in step 136) the costs of all the predicted individual event costs to obtain a total predicted cost of resolving the events individually, Cₑᵥₑₙₜₛ, where Cₑᵥₑₙₜₛ=Σ₀ⁿCₙ.

In further embodiments, the uncorrelated event cost prediction model 150 is a machine learning model trained to predict resource costs for resolving individual events based on input vectors defining features of the individual events and trained resource cost outputs.

Then, the method of flow diagram 120 combines the two branches to calculate the difference between the predicted correlation group cost C_{group} and the total predicted cost of resolving the events individually Cₑᵥₑₙₜₛ, giving a cost reduction metric of ΔC (step 137).

Further, the method of flow diagram 120 ranks the list of inferred correlation groups by the cost reduction metric ΔC, with the inferences with the greatest potential cost reduction listed first (step 138). In an example embodiment, step 138 allows a user to prioritize the most beneficial inferences in terms of cost reduction.

The method of flow diagram 120 further includes selecting and processing a correlation group or individual events (step 139). Further, after processing, step 139 can include providing the cost feedback of the resolution to the correlation group event cost prediction model 140 and the uncorrelated event cost prediction model 150, as appropriate.

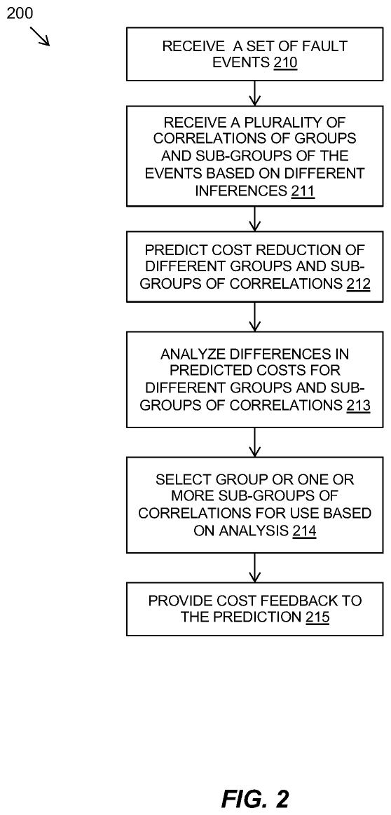

Referring to FIG. 2, a flow diagram 200 illustrates another example embodiment of the described method carried out by a computer system for predicting cost reduction of event correlation in fault event management. In various embodiments, flow diagram 200 can be representative of processes and steps of a program and/or application that system 400 (depicted in FIG. 4) executes, in accordance with embodiments of the present invention.

As in the first example embodiment of FIG. 1A, the method of flow diagram 200 can receive a set of fault events (step 210) and receive a plurality of candidate correlation groups of events applying inferences to groups of events within the set of fault events (step 211). In various embodiments, the plurality of candidate correlation groups of events may be provided by a correlation system and are based on different discovered inferences between events.

In this example embodiment, for each candidate correlation group of events the method of flow diagram 200 predicts a resource cost reduction in resolving the full correlation group of all the events compared to one or more sub-groups of the correlation group of events (step 212). The sub-groups may have different event member groupings within the correlation group. In various embodiments, the sub-groups may be selected to determine optimal combinations of events in a correlation group.

The prediction of the resource cost reduction for the group and sub-groups (of step 212) may use the previously described method of comparing the cost reduction of the group or sub-group with the sum of the cost reduction of individual events, in accordance with various embodiments of the present invention.

In addition, the method of flow diagram 200 may analyze the differences in cost reductions for the correlated group and correlated sub-groups of events (step 213). Step 213 can include comparing the cost reduction of the correlated group to the sum of the correlated sub-groups that make up the full group of events. Further, the method of flow diagram 200 can utilize the analysis to select a candidate correlation group or one or more correlation sub-groups based on the cost reductions (step 214).

Once a correlation group of events is selected and used for resolving the group of events, the method of flow diagram 200 can provide cost feedback to the prediction (step 215). In various embodiments, providing cost feedback can improve the accuracy of future predictions.

To illustrate example embodiments of the described method further, the following simplified examples are provided.

A set of fault events is received with each event having information relating to the event. The information is used to find inferences and correlate groups of events from within the set. Correlations may be discrete or may be overlapping in the events that the correlations cover.

Scenario 1 finds discrete correlation groups. Correlation 1 is for the group of events [A, B, C, D, E, F] with the inference being a common resource P. Correlation 2 is found for the group of events [G, H, I, J, K] with the inference being a type Q of event. Correlation 3 is found for the group of events [L, M, N] with the inference being that it effects application R.

Scenario 2 finds overlapping correlation groups. Correlation 4 is for the group of events [A, B, C, D, E, F] with the inference being a common resource P. Correlation 5 is found for the group of events [A, C, E, G, H] with the inference being a type Q of event. Correlation 6 is found for the group of events [B, C, D, H, F] with the inference being that it effects application R.

For each correlation group, embodiments of the present invention compare the predicted cost of resolving the group of correlation 1 of [A, B, C, D, E, F] to the predicted costs of resolving the individual events A, B, C, D, E, F and summing the individual costs.

The difference score indicating the cost saving of using the correlation may be used in the discrete correlation scenario to rank correlation 1 against the difference score for other correlations, such as, the difference score for correlation 2 and the difference score for correlation 3. Further, embodiments of the present invention can identify the correlation with the biggest cost saving. Each correlation group is potentially valid and works independently. The reason for the ranking can be purely to help optimize the ratio of time spent validating the groups compared to the reduction in costs.

In another embodiment, the same technique may be used to compare the relative benefit of deploying a correlation group compared to other similar overlapping correlation groups, such as correlations 4, 5, 6 above. The ranking may be used to select a correlation in place of a different correlation due to the overlap.

In a further embodiment, sub-groups of events of a correlated group of events may be considered and cost savings compared as described below.

Various embodiments of the present invention can compare the predicted cost of resolving the group of correlation 1 of [A, B, C, D, E, F] to the cost of resolving sub-groups [A, B, C] and [D, E, F]. For example, comparing the predicted cost of each sub-group [A, B, C] to the individual event costs of A, B, C summed together resulting in an analysis of the cost saving for the correlation for the sub-group.

In further embodiments, scenarios may exist where sub-groups cost less to resolve than a whole group. For example, due to information silos across teams, where it is better for two teams to resolve two things independently and then to come together, rather than one team attempting to resolve all the events when they do not know all the facts. In the example, there would be three cost reduction figures: 1. [A, B, C, D, E, F]; 2. [A, B, C]; and 3. [D, E, F].

The predicted costs would be different if you rank based on the larger correlation group [A, B, C, D, E, F] compared to the sub-groups [A, B, C] and [D, E, F].

For this case, the summed cost reduction of each possible partitioning of the group may be compared and the highest cost savings put forward for review. The analysis may take into account a size and overlap of the events in the correlation group and/or sub-groups.

The smaller correlation groups may be presented within the ranked list individually (e.g. [A, B, C] and [D, E, F]), where the respective rank is the individual cost reduction. Alternatively, the smaller correlation groups may be presented as a group of subgroups within the ranking (e.g. [[A, B, C] [D, E, F]]), where the respective rank is the sum of the two cost reductions, which can be compared to the cost reduction of the full group [A, B, C, D, E, F].

An advantage of this embodiment is providing additional information about which correlations are most beneficial and may help if the larger correlation is erroneous. For example: Events A, B, C originate from a network issue which is causing events D, E, F which originate from application monitoring. The system detects this as correlation groups: [A, B, C, D, E, F]; [A, B, C], [D, E, F].

In the past, due to communication issues between the networks team and the applications team, the cost to resolve groups which contain all of the events has increased, due to taking time to co-ordinate between the teams. However, the cost is less when the network-related events were grouped separately to the application events. The application team were able to quickly work around the issue and restore service, and the network team quickly came to a resolution for the underlying cause.

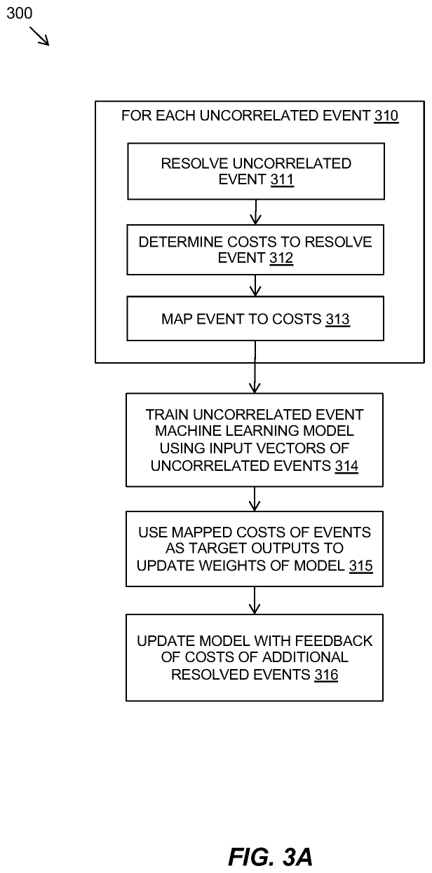

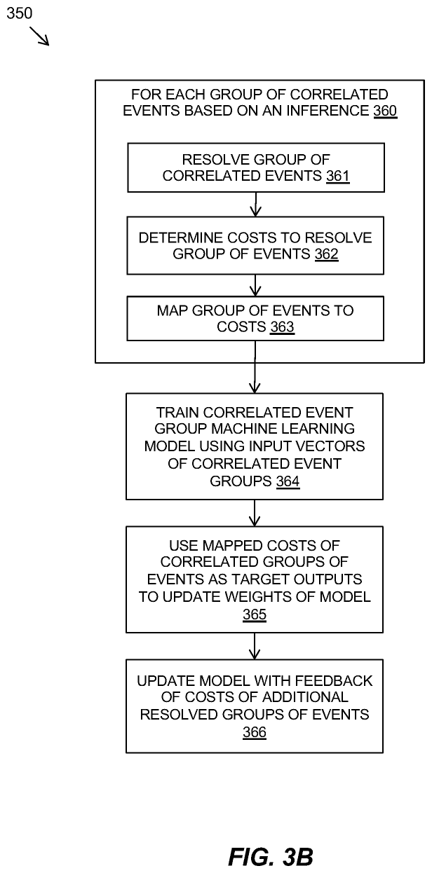

Referring to FIG. 3A, flow diagram 300 shows an example embodiment of the aspect of the described method of training an uncorrelated event cost prediction model 150, in accordance with various embodiments of the present invention. In example embodiments, the process of training an uncorrelated event cost prediction model 150 may be achieved with a Long-Short Term Memory (LSTM) or Recurrent Neural Network (RNN) with a Rectified Linear Unit (ReLU) activation function. Alternative embodiments can utilize a Linear Regression model. In various embodiments, flow diagram 300 can be representative of processes and steps of a program and/or application that system 400 (depicted in FIG. 4) executes, in accordance with embodiments of the present invention.

For each uncorrelated event, the method of flow diagram 300 performs process 310, which includes resolving an uncorrelated event (step 311), determining the costs associated with the resolution (e.g., in terms of time taken to resolve the event, resource downtime, etc.) of the uncorrelated event (step 312), and mapping the determined costs (step 313) to the event. In various embodiments, the costs of events may be input by an operator or may be automatically estimated. For example, every time an event is resolved as part of Root Cause Analysis (RCA), the operator performing RCA may specify the cost of resolving the event. An automated embodiment may collect the total amount of time spent on the event multiplied by the number of operators who worked on the event. However, asking for confirmation of this cost, or requiring manual input may provide more accurate results.

In step 314, the method of flow diagram 300 trains a machine learning model using input vectors relating to characteristics of the uncorrelated events. In step 315, the method of flow diagram 300 uses the mapped costs as the target outputs for resolving the events to update the weights of the model. Further, in step 316, the method of flow diagram 300 can update the machine learning model with feedback of costs of additionally resolved groups of correlated events.

Referring to FIG. 3B, flow diagram 350 shows an example embodiment of the aspect of the described method of training a correlated event cost prediction model 140, in accordance with various embodiments of the present invention. In example embodiments, the process of training an uncorrelated event cost prediction model 140 may be achieved with a Long-Short Term Memory (LSTM) or Recurrent Neural Network (RNN) with a Rectified Linear Unit (ReLU) activation function. Alternative embodiments can utilize a Linear Regression model. In various embodiments, flow diagram 350 can be representative of processes and steps of a program and/or application that system 400 (depicted in FIG. 4) executes, in accordance with embodiments of the present invention.

For each correlation group of events based on an inference, the method of flow diagram 350 performs process 360, which includes resolving the group of correlates events (step 361), determining the costs associated with the resolution (e.g., in terms of time taken to resolve the group of events, resource downtime, etc.) of the group of events (step 362), and mapping the group of events to costs (step 363).

In step 364, the method of flow diagram 350 trains a machine learning model using input vectors relating to characteristics of the correlated event groups. In example embodiments, the machine learning model may also be trained for sub-groups of a correlation group of events. In step 365, the method of flow diagram 350 uses the mapped costs as the target outputs for resolving the events to update the weights of the machine learning model.

In example embodiments, every time a correlation group of events is resolved, as part of Root Cause Analysis (RCA), the operator performing RCA may specify the cost of resolving the event. An automated example embodiment can determine the total amount of time spent on a correlation group of events multiplied by the number of operators who worked on the correlated group of events. However, asking for confirmation of this cost, or requiring manual input may provide more accurate results. Further, in step 366 the method of flow diagram 350 can update the machine learning model with feedback of costs of additionally resolved groups of correlated events.

In various embodiments, the resource costs measured for an event or a group of events may include: personnel time required to resolve; resource downtime to resolve; and loss of service cost to resolve. In further embodiments, the input vectors define features or characteristics of the correlations of groups of events. For example, severity of events in the group, source of group (e.g., list of locations), number of events in the group, number of resourced affected, patterns of when this group tends to occur, duration of the group of events, frequency of words in group (e.g., tokenized one-hot encoded word counts), degree of connectivity for events that match resources of a topology in the group, etc.

In additional embodiments, the input vectors define features or characteristics of the individual events. For example, when the fault occurred (e.g., last occurrence/first occurrence), wow severe the fault was (e.g., severity), where the fault occurred (e.g., node, node alias, location etc.), a description of the fault (e.g., identifier, summary, alert group etc.), etc.

Training the Event Cost Prediction Model:

In an example embodiment, the uncorrelated event cost prediction model is a machine learning model trained using input vectors of events, such as the examples given in Table 1 below, with target outputs of the associated cost in terms of service downtime, and monetary costs such as person hours, and loss of service cost, as shown in Table 2 below. In various embodiments, every time an event is resolved, as part of Root Cause Analysis (RCA), the operator performing RCA is required to specify the cost of resolving the event. In further embodiments, every time an event is resolved and the RCA process is performed, the weights of the event cost prediction model will update.

TABLE 1
Input vector of events:

| Name | Description |
|---|---|
| Identifier | This is the key used in the source system to de-duplicate |
| | events of this type. |
| Node | The source of the event. |
| Node Alias | The source alias of the event. |
| Alert Group | The descriptive name of the failure type indicated by the |
| | alert. |
| Summary | Contains text which describes the event condition. |
| Severity | The event severity. |
| Last | The time the current event occurred. |
| Occurrence | |
| Type | The type of alarm, where type refers to the problem or |
| | resolution state of the event. |
| Manager | The descriptive name of the probe that collected and |
| | forwarded the event. |
| Agent | The describe name of the sub-manager that generated the |
| | event. |
| Location | Indicates the physical location of the device, host, or |
| | service for which the alert was generated. |
| Service | The name of the service affected by this event. |
| Physical Port | The port number indicated by the event. |
| Physical Slot | The slot number indicated by the event. |
| Physical Card | The card name or description indicated by the event. |
| Local Primary | The primary object referenced by the event. |
| Object | |
| Local Root | An object that is equivalent to the primary object |
| Object | referenced in the event. |
| URL | Optional URL which provides a link to additional |
| | information in the vendor's device. |
| Event Id | The event ID (for example, SNMPTRAP-link down |
| | (Simple Network Management Protocol Trap)). |
| | Multiple events can have the same event ID. |
| First | The time the event occurred first. |
| Occurrence | |

TABLE 2
Target outputs for events:

| Name | Description |
|---|---|
| Person | The number of person hours required to resolve the event. |
| hours | |
| Loss of | The cost of the outage this event relates to. |
| service cost | |

Training the Correlation Group Cost Prediction Model:

In an example embodiment, the correlation group cost prediction model is a machine learning model trained using input vectors of correlation groups, such as the examples given in Table 3 below, with target outputs of the associated cost in terms of service downtime, and monetary costs such as person hours, and loss of service cost, as shown in Table 4 below. In additional embodiments, every time a group of events is resolved, as part of Root Cause Analysis (RCA), the operator performing RCA is required to specify the cost of the resolving the group of events. In a further embodiment, each time a correlation group is resolved and this RCA process is performed, the weights of the Correlation Group Cost Prediction Model will update.

TABLE 3
Input vector of correlation groups:

| Name | Description |
|---|---|
| Max Severity | The number of events in the inference. |
| Correlation | The maximum severity with all events in the inference. |
| of Enrichment | |
| type | |
| Group | If the algorithm of correlation or enrichment type. |
| Generation | |
| Algorithm | |
| Number of | The number of instances of this group. |
| Instances | |
| Mode Severity | The mode severity of the events within the group. |
| Median Severity | The median severity of the events within the group. |
| Event Reduction | The number of individual events that would have been |
| | correlated due to this grouping. |
| Number of | The number of unique resources found in the events. |
| Unique Nodes | |
| Number of | The number of resources that would have been |
| Resources | impacted by these events (resources with severity |
| Affected | status of issue threshold level). |
| Seasonal Trend | The seasonal probability value score for this group. |
| Average | The average time between re-occurrences of this |
| Re-occurrence | potential grouping if it was previously deployed |
| Rate | for live inferences. |
| Mode | The mode re-occurrence rate of the potential group. |
| Re-occurrence | |
| Rate | |
| Min | The shortest time of re-occurrence for this group. |
| Re-occurrence | |
| Rate | |
| Number of | The number of flapping events contained within |
| Flapping Events | this group. |
| Tokenized | One-hot encoded vector representation of words in |
| Word Count | summaries with removed stop words. |
| Tokenized | List the services that are affected by the correlation |
| Services Vector | group and create a vector from it. |
| with Counts | |
| Group Node | A vector describing the interconnectedness of the |
| Connectivity | events by their node field. |
| Vector | |

TABLE 4
Target outputs for groups of events:

| Name | Description |
|---|---|
| Person hours | The number of person hours required to resolve the |
| | event group. |
| Loss of | The cost of the outage(s) this group of events |
| service cost | relates to. |

The described method and system work toward optimizing the effort required to review the results of a system generating correlation rules for event faults. The method obtains a cost comparison between the resolution of an automatically generated correlation group of faults in a system, versus the cost of resolving them when not correlated. The method obtains the cost benefit of deploying a correlation rule based on a model of historical costs of resolving correlated faults versus uncorrelated faults. Ranking inferences for group correlations by higher differences in the costs of resolving the group compared to individually resolving the events, allows an operations team to prioritize the review of inferences which will result in the greatest cost reduction.

The method estimates the cost benefit an operations team would receive if they were to deploy a correlation rule based on an inference made by an analytics system. In order to achieve this, embodiments of the present invention can utilize a three-stage process.

In stage one, after the resolution of each uncorrelated event, the operations team is asked to provide both the time taken to resolve the issue as well as the cost to service. For example, provided as part of a root cause analysis. Embodiments of the present invention can utilize the provided information to train a model that creates a mapping between events and cost.

In stage two, after the resolution of each correlation group of events, the same questions are asked as in stage one. Embodiments of the present invention can utilize the provided information to train a model which creates a mapping between event group characteristics and cost.

In stage three, when the operations team comes to review the list of inferences, each inference is passed through the model to give a predicted correlated and predicted uncorrelated cost. Embodiments of the present invention can utilize the difference between the two metrics is used in order to determine how beneficial each inference could be. Inferences with a larger difference will be ranked higher by the system than those with a smaller difference. In example embodiments, the ranking will allow the operations team to prioritize the review of inferences which will result in the greatest cost reduction.

Referring to FIG. 4, the depicted block diagram shows an example embodiment of system 400 in which the described system may be implemented including a fault event management system 410 provided by a computer system, and including the described correlation cost prediction system 420, an associated correlation system 430, and a root cause analysis system 440.

The computing system of the fault event management system 410 includes at least one processor 411, a hardware module, or a circuit for executing the functions of the described components which may be software units executing on the at least one processor. Multiple processors running parallel processing threads may be provided enabling parallel processing of some or all of the functions of the components. Memory 412 may be configured to provide computer instructions 413 to the at least one processor 411 to carry out the functionality of the components.

A machine learning system 450 may be provided locally or remotely to the fault event management system 450 (e.g., connected via network communications, not shown) to train and provide the correlation group event prediction model 140 and the uncorrelated event cost prediction model 150. The machine learning system 450 may be provided by a computer system including at least one processor 451, a hardware module, or a circuit for executing the functions of the described components which may be software units executing on the at least one processor. Multiple processors running parallel processing threads may be provided enabling parallel processing of some or all of the functions of the components. Memory 452 may be configured to provide computer instructions 453 to the at least one processor 451 to carry out the functionality of the components.

The machine learning system 450 may include a correlation group training component 455 and an individual event training component 454. The correlation group training component 455 and the individual event training component 454 may receive training feedback from a root cause analysis system 440 of the fault event management system 410.

The correlation cost prediction system 420 may include a correlation receiving component 421 for receiving a plurality of candidate correlations of groups of events in a set of fault events from the correlation system 430. The plurality of candidate correlations of groups of events in a set of fault events are provided by the correlation system 430 and are based on different discovered inferences between events.

The correlation cost prediction system 420 may include a cost prediction component 422, for each candidate correlation of a group of events, predicting a resource cost reduction in resolving the correlated of a group of events compared to resolving all the events in the group individually. The cost prediction component 422 may include a correlation prediction component 423 for predicting a first resource cost of resolving as a group the correlation group of events and that applies the correlation group event cost prediction model 140 trained to predict resource costs for resolving correlation groups of events based on input vectors defining features of the correlation groups.

The cost prediction component 422 may also include an individual event prediction component 424 for predicting a second resource cost of a sum of the costs of resolving the events in the group individually and that applies the uncorrelated event cost prediction model 150 trained to predict resource costs for resolving individual events based on input vectors defining features of the individual events. The cost prediction component 422 also includes a cost reduction prediction component 425 for calculating a difference in the first and second predicted resource costs to obtain the predicted resource cost reduction.

The correlation cost prediction system 420 may include an analyzing component 426 for analyzing the predicted resource cost reductions for the plurality of candidate correlations of groups of events and a selecting component 427 for selecting a candidate correlation of a group based on the ranking of predicted resource cost reductions.

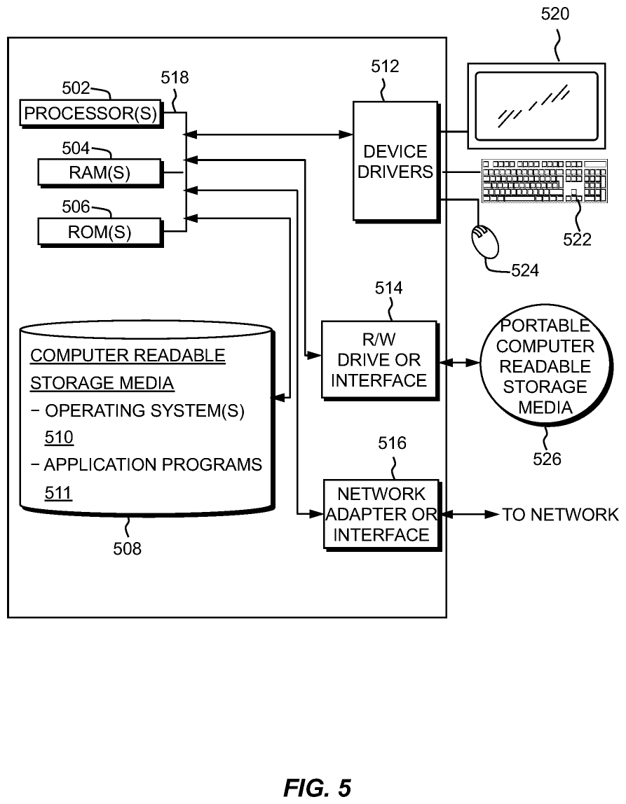

FIG. 5 depicts a block diagram of components of the computing system of the fault event management system 410 and the machine learning system 450 of FIG. 4, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

The computing system can include one or more processors 502, one or more computer-readable RAMs 504, one or more computer-readable ROMs 506, one or more computer readable storage media 508, device drivers 512, read/write drive or interface 514, and network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within the system.

One or more operating systems 510, and application programs 511, such as the correlation cost prediction system 420, the correlation system 430 and the root cause analysis system 440 are stored on one or more of the computer readable storage media 508 for execution by one or more of the processors 502 via one or more of the respective RAMs 504 (which typically include cache memory). In the illustrated embodiment, each of the computer readable storage media 508 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

The computing system can also include a R/W drive or interface 514 to read from and write to one or more portable computer readable storage media 526. Application programs 511 on the computing system can be stored on one or more of the portable computer readable storage media 526, read via the respective R/W drive or interface 514 and loaded into the respective computer readable storage media 508.

The computing system can also include a network adapter or interface 516, such as a TCP/IP adapter card or wireless communication adapter. Application programs 511 on the computing system can be downloaded to the computing device from an external computer or external storage device via a network (for example, the Internet, a local area network or other wide area networks or wireless networks) and network adapter or interface 516. From the network adapter or interface 516, the programs may be loaded into the computer readable storage media 508. The network may comprise copper wires, optical fibers, wireless transmission, routers, firewalls, switches, gateway computers and edge servers.

The computing system can also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514, and network adapter or interface 516 can comprise hardware and software stored in computer readable storage media 508 and/or ROM 506.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or both.

Cloud Computing:

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

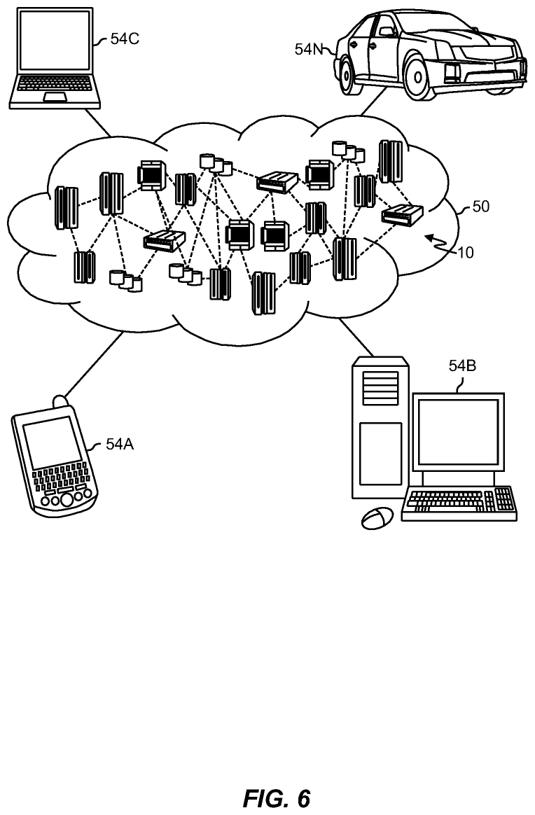

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

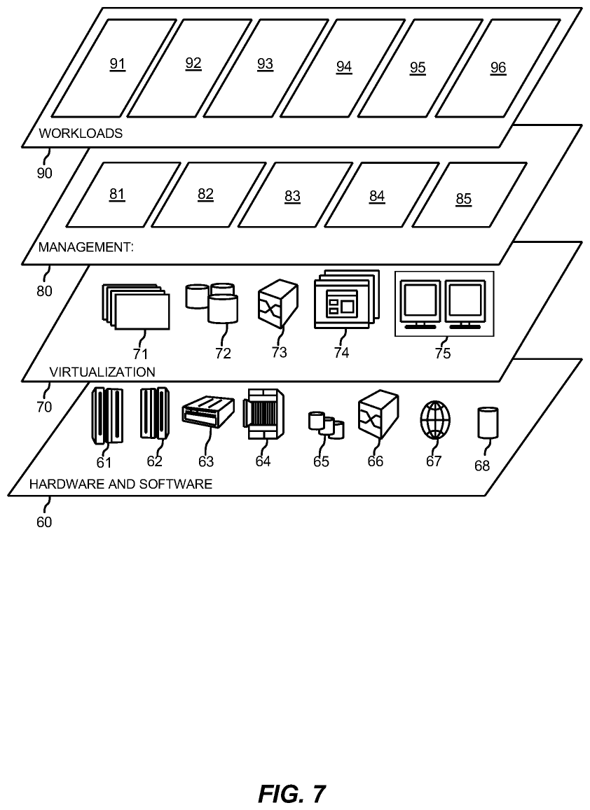

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and fault management processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention. [symbol] er devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing:

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and fault management processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method comprising:
receiving, by one or more processors, a plurality of candidate correlation groups of events in a set of fault events;
for each candidate correlation group of events, predicting, by one or more processors, a resource cost reduction in resolving the respective correlation group of events compared to resolving all events in the respective correlation group individually;
analyzing, by one or more processors, the predicted resource cost reductions for the plurality of candidate correlation groups of events; and
selecting, by one or more processors, a candidate correlation group based on the analysis of predicted resource cost reductions.

2. The method as claimed in claim 1, wherein predicting a resource cost reduction for resolving each candidate correlation of a group of events further comprises:
predicting, by one or more processors, a first resource cost of resolving the correlation group of events as a group;
predicting, by one or more processors, a second resource cost as a sum of costs of resolving the events in the group individually; and
calculating, by one or more processors, a difference in the first and second predicted resource costs to determine the predicted resource cost reduction.

3. The method as claimed in claim 1, wherein analyzing the predicted resource cost reductions further comprises:
ranking, by one or more processors, the candidate correlation groups of events by the predicted resource cost reduction.

4. The method as claimed in claim 1, wherein the candidate correlation groups are discrete groups of events or groups with overlapping events including sub-groups of events.

5. The method as claimed in claim 4, wherein analyzing the predicted resource cost reduction further comprises:
calculating, by one or more processors, combined predicted cost reductions of sub-group of events; and
comparing, by one or more processors, the result to a predicted cost reduction of a whole group of events.

6. The method as claimed in claim 2, wherein the resource costs are measured for an event or a group of events as one or more selected from the group consisting of: personnel time required to resolve, resource downtime to resolve, and loss of service cost to resolve.

7. The method as claimed in claim 2, wherein predicting a first resource cost further comprises:
applying, by one or more processors, a first machine learning model trained to predict resource costs for resolving correlation groups of events based on input vectors defining features of the correlations.

8. The method as claimed in claim 7, wherein the input vectors define features of the correlations in the form of one or more selected from the group consisting of: a severity of events in the group, a source of each event in the group, a number of events in the group, a number of resourced affected, patterns of when the group occurs, a duration of the group, a frequency of words in the group, and a degree of connectivity for events that match resources of a topology in the group.

9. The method as claimed in claim 7, further comprising:
providing, by one or more processors, feedback to the first machine learning model of resource costs of resolving a correlation group of events for continued training of the model.

10. The method as claimed in claim 2, wherein predicting a second resource cost further comprises:
applying, by one or more processors, a second machine learning model trained to predict resource costs for resolving individual events based on input vectors defining features of the individual events.

11. The method as claimed in claim 10, wherein the input vectors define features of the individual events in the form of one or more selected from the group consisting of: when the event occurred; a severity of the event; a location of the event; a description of the event.

12. The method as claimed in claim 10, further comprising:
providing, by one or more processors, feedback to the second machine learning model of resource costs of resolving individual events for continued training of the model.

13. The method as claimed in claim 1, wherein the plurality of candidate correlations of groups of events in a set of fault events are provided by a correlation system and are based on different discovered inferences between events.

14. A computer system comprising:
one or more computer processors;
one or more computer readable storage media; and
program instructions stored on the computer readable storage media for execution by at least one of the one or more processors, the program instructions comprising:
program instructions to receive a plurality of candidate correlation groups of events in a set of fault events;
program instructions, for each candidate correlation group of events, to predict a resource cost reduction in resolving the respective correlation group of events compared to resolving all events in the respective correlation group individually;
program instructions to analyze the predicted resource cost reductions for the plurality of candidate correlation groups of events; and
program instructions to select a candidate correlation group based on the analysis of predicted resource cost reductions.

15. The computer system of claim 14, wherein the program instructions to predict a resource cost reduction for resolving each candidate correlation of a group of events further comprise program instructions to:
predict a first resource cost of resolving the correlation group of events as a group;
predict a second resource cost as a sum of costs of resolving the events in the group individually; and
calculate a difference in the first and second predicted resource costs to determine the predicted resource cost reduction.

16. The computer system of claim 15, wherein the program instructions to predict the first resource cost further comprise program instructions to:
apply a first machine learning model trained to predict resource costs for resolving correlation groups of events based on input vectors defining features of the correlations.

17. The computer system of claim 15, wherein the program instructions to predict the first resource cost further comprise program instructions to:
apply a second machine learning model trained to predict resource costs for resolving individual events based on input vectors defining features of the individual events.

18. A computer program product comprising:
one or more computer readable storage media and program instructions stored on the one or more computer readable storage media, the program instructions comprising:
program instructions to receive a plurality of candidate correlation groups of events in a set of fault events;
program instructions, for each candidate correlation group of events, to predict a resource cost reduction in resolving the respective correlation group of events compared to resolving all events in the respective correlation group individually;
program instructions to analyze the predicted resource cost reductions for the plurality of candidate correlation groups of events; and
program instructions to select a candidate correlation group based on the analysis of predicted resource cost reductions.

19. A computer-implemented method comprising:
providing a first machine learning model trained to predict resource costs for resolving correlation groups of events based on input vectors defining features of the correlation groups;
providing a second machine learning model trained to predict resource costs for resolving individual events based on input vectors defining features of the individual events;
for a discovered correlation of a group of events:
applying, by one or more processors, the first machine learning model to predict a resource cost for resolving the group of events as a correlation group;
applying, by one or more processors, the second machine learning model to predict a resource cost for resolving the group of events as individual events; and
predicting, by one or more processors, a resource cost reduction in resolving a correlated of a group of events compared to a total resource cost of resolving all the events in the group individually.

20. The method as claimed in claim 19, wherein providing a first machine learning model trained to predict resource costs for resolving correlation groups of events based on input vectors defining features of the correlation groups further comprises:
training, by one or more processors, the first machine learning model based on resolved correlation group event analysis including resource cost feedback of correlation groups of events.

21. The method as claimed in claim 19, wherein providing a second machine learning model trained to predict resource costs for resolving individual events based on input vectors defining features of the individual events further comprises:
training, by one or more processors, the second machine learning model based on resolved event analysis including resource cost feedback of individual events.

22. A computer-implemented method comprising:
training, by one or more processors, a first machine learning model to predict resource costs for resolving correlation groups of events based on input vectors defining features of the correlation groups;
training, by one or more processors, a second machine learning model to predict resource costs for resolving individual events based on input vectors defining features of the individual events;
providing, by one or more processors, the first machine learning model for predicting a resource cost for resolving a group of events as an input correlation group;
providing, by one or more processors, the second machine learning model for predicting a resource cost for resolving the group of events in the input correlation group as individual events; and
predicting, by one or more processors, a resource cost reduction in resolving the correlation group of events as a correlation group compared to a total resource cost of resolving all the events in the group individually.

23. The method as claimed in claim 22, wherein training the first machine learning model to predict resource costs for resolving correlation groups of events is based on resolved correlation group event analysis including resource cost feedback of correlation groups of events.

24. The method as claimed in claim 22, wherein training the second machine learning model to predict resource costs for resolving individual events is based on resolved event analysis including resource cost feedback of individual events.

25. The method as claimed in claim 22, further comprising:
receiving, by one or more processors, feedback to the first machine learning model of resource costs of resolving a correlation group of events for continued training of the model; and
receiving, by one or more processors, feedback to the second machine learning model of resource costs of resolving individual events for continued training of the model.
